(19) United States
(12) Patent Application Publication
(10) Pub. No.: US 2021/0058362 A1
(43) Pub. Date: Feb. 25, 2021

(54) EQUIPMENT INFERENCE DEVICE, EQUIPMENT INFERENCE METHOD, AND EQUIPMENT INFERENCE PROGRAM

(71) Applicant: NIPPON TELEGRAPH AND TELEPHONE CORPORATION, Tokyo (JP)

(72) Inventors: Tsuyoshi KONDO, Musashino-shi (JP); Shingo KASHIMA, Musashino-shi (JP)

(73) Assignee: NIPPON TELEGRAPH AND TELEPHONE CORPORATION, Tokyo (JP)

(21) Appl. No.: 16/963,839

(22) PCT Filed: Feb. 21, 2019
(86) PCT No.: PCT/JP2019/006649

§ 371 Date: Jul. 22, 2020

(30) Foreign Application Priority Data
Feb. 21, 2018 (JP) 2018-028478

(51) Int. Cl. H04L 29/12; G06F 8/70; G06N 20/00

(52) U.S. Cl. CPC H04L 61/1511; G06N 20/00; G06F 8/70

(57) ABSTRACT

A device estimation apparatus includes: a DNS query acquisition unit (121) configured to acquire a DNS query from a device to be estimated; an aggregation unit (122) configured to aggregate contents of the acquired DNS query for each of the devices that are transmission sources of the DNS query; a comparison source data generation unit (123) configured to generate comparison source data including entries in which models of devices, software used by the devices, and an aggregation result of contents of DNS queries transmitted from the devices are associated with each other; and an estimation unit (124) configured to extract, from the comparison source data, an entry similar to an aggregation result of contents of the DNS query transmitted from the device to be estimated and to estimate, as a model and software of the device to be estimated, a model and software indicated in the extracted entry.

### TECHNICAL FIELD

The present invention relates to a device estimation apparatus, a device estimation method, and a device estimation program.

### BACKGROUND ART

In the related art, there has been a technique for estimating a device, which is a transmission source of a DNS query, using a DNS (Domain Name System) query pattern transmitted from a device in a network (see Non-Patent Literature 1).

### CITATION LIST

### Non-Patent Literature

Non-Patent Literature 1: Estimation of OS using DNS query pattern, [Search on Feb. 1, 2018], Internet <URL:https://www.goto.info.waseda.ac.jp/forB4/pdf-th/2009/0201_kawaguchi.pdf>

### SUMMARY OF THE INVENTION

### Technical Problem

However, the technique disclosed in Non-Patent Literature 1 is applied only to a network environment in which IPv4 (Internet Protocol version 4) and IPv6 (Internet Protocol version 6) are used in combination, and an estimation target is limited only to an OS (Operating System) of a device in the technique. Therefore, an object of the present invention is to estimate a model of a device in a network and software installed in the model even in a network environment other than a network environment in which IPv4 and IPv6 are used in combination.

### Means for Solving the Problem

To solve the above problems, the present invention is characterized by including: a comparison source data generation unit configured to generate comparison source data that is a set of entries in which models of devices connected to a network, software used by the devices, and an aggregation result of contents of DNS queries transmitted from the devices are associated with each other; a DNS query acquisition unit configured to acquire a DNS query from a device to be estimated; an aggregation unit configured to aggregate contents of the acquired DNS query for each of the devices that are transmission sources of the DNS query; and an estimation unit configured to extract, from the comparison source data, an entry similar to an aggregation result of contents of the DNS query transmitted from the device to be estimated and to estimate, as a model and software of the device to be estimated, a model and software indicated in the extracted entry.

### Effects of the Invention

According to the present invention, it is possible to estimate a model of a device in a network and software installed in the model even in a network environment other than a network environment in which IPv4 and IPv6 are used in combination.

### BRIEF DESCRIPTION OF DRAWINGS

FIG. 1 is a diagram showing a configuration example of a system and a configuration example of a device estimation apparatus.

FIG. 2 is a diagram showing a modification example of the configuration of the system in FIG. 1.

FIG. 3 is a diagram showing an example of comparison source data in FIG. 1.

FIG. 4 is a flowchart showing an example of a processing procedure of the device estimation apparatus in FIG. 1.

FIG. 5 is a diagram showing a computer that executes a device estimation program.

### DESCRIPTION OF EMBODIMENT

An embodiment of the invention will be described below with reference to the drawings. In the following description, a device is, for example, an IoT (Internet of Things) device or an ICT (Information and Communication Technology) device. A model of the device is, for example, a manufacturer name or a model number of the device. Further, software includes not only an OS but also applications. The present invention is not limited to the following embodiment.

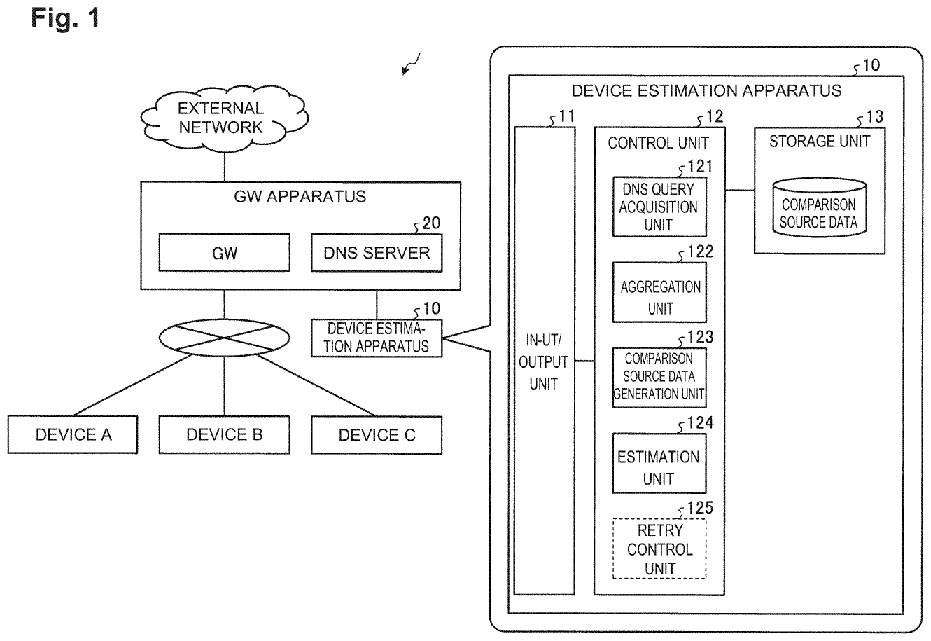

As shown in FIG. 1, a system of the present embodiment includes, for example, a plurality of devices (for example, devices A, B, and C), a GW (gateway) apparatus through which the respective devices are connected to an external network, and a device estimation apparatus 10. The GW apparatus includes a GW and a DNS server 20.

The GW is used to connect the respective devices (for example, devices A, B, and C) to the external network (for example, Internet). In addition, upon receiving a DNS query of each of the devices through the GW, the DNS server 20 returns a response of the DNS query.

The device estimation apparatus 10 acquires the DNS query of each of the devices from the DNS server 20, and estimates a model of each of the devices and an OS and an application used by each of the devices, based on the acquired DNS query.

For example, the device estimation apparatus 10 generates comparison source data in which the contents of a DNS query transmitted from each of the devices (for example, devices A and B) whose model, OS, and application are known in advance are aggregated. Note that the aggregation result of the DNS query is associated with information on the model, OS, and application of the device that is a transmission source of the DNS query. Then, upon acquiring a DNS query transmitted from the device (for example, device C) to be estimated, the device estimation apparatus 10 aggregates the contents of the DNS query. Then, the device estimation apparatus 10 extracts an entry, which is similar to the aggregation result of the contents of the DNS query transmitted from the device to be estimated, from the generated comparison source data. Then, the device estimation apparatus 10 estimates the model, OS, and application indicated in the extracted entry as the model, OS, and application of the device to be estimated.

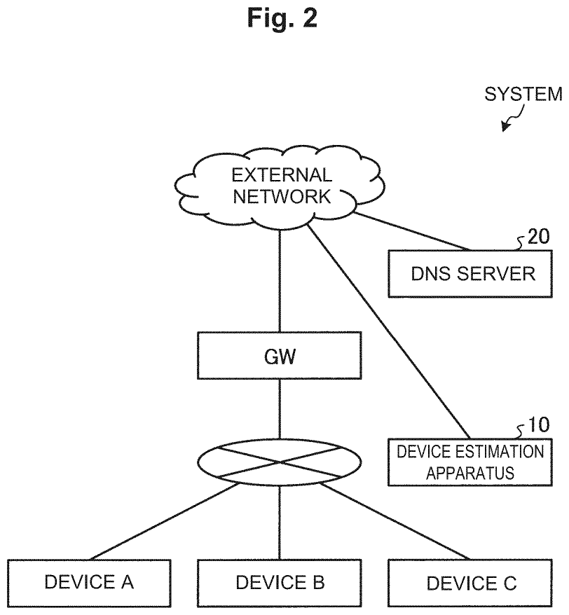

The device estimation apparatus 10 may directly acquire the DNS query of each of the devices from the DNS server 20 as shown in FIG. 1, or may acquire the DNS query of each of the devices from the DNS server 20 through the external network as shown in FIG. 2. In addition, the device estimation apparatus 10 may acquire the DNS query of each of the devices by acquiring and analyzing traffic to the DNS server 20. Note that there is a device that directly specifies the DNS server 20 and issues a DNS query. Thus, the device estimation apparatus 10 may acquire the DNS query of each of the devices by acquiring and analyzing the DNS query passing through the GW. Here, the situation in which the device directly specifies the DNS server 20 means, for example, a situation in which Google Public DNS (registered trademark) (8.8.8.8) is directly set in the devices A, B, and C and the DNS query is not issued to the DNS server 20 (see FIG. 1) integrated with the GW apparatus.

Returning to FIG. 1, the device estimation apparatus 10 will be described in detail. For example, as shown in FIG. 1, the device estimation apparatus 10 includes an input/output unit 11, a control unit 12, and a storage unit 13.

The input/output unit 11 acts as an interface for data input/output with an external apparatus. For example, the input/output unit 11 receives an input of a DNS query serving as comparison source data or the DNS query transmitted from the device to be estimated, or outputs an estimation result of a model, an installed OS, and an application of the related device.

The control unit 12 controls the entire device estimation apparatus 10. The control unit 12 includes a DNS query acquisition unit 121, an aggregation unit 122, a comparison source data generation unit 123, and an estimation unit 124. A retry control unit 125 indicated by a broken line may or may not be provided, and the case where the retry control unit 125 is provided will be described below.

The DNS query acquisition unit 121 acquires a DNS query from each device. For example, the DNS query acquisition unit 121 acquires, as a DNS query for comparison source data, a DNS query from a device whose model, OS, and application are known in advance. In addition, the DNS query acquisition unit 121 acquires a DNS query from a device to be estimated.

The aggregation unit 122 aggregates the contents of the DNS query, which is acquired from each device by the DNS query acquisition unit 121, for each device (IP address or MAC address of the transmission source) that is a transmission source of the DNS query.

For example, a case where a DNS query group acquired by the DNS query acquisition unit 121 is a DNS query group transmitted from the device A and the device B is assumed. In this case, when the DNS query group transmitted from the device A is a DNS query regarding “example5.com” and a DNS query regarding “example6.com”, the aggregation unit 122 aggregates the “example5.com” and the “example6.com” as the DNS query of the device A. Further, when the DNS query group transmitted from the device B is a DNS query regarding “example1.com” and a DNS query regarding “example3.com”, the aggregation unit 122 aggregates the “example1.com” and the “example3.com” as the DNS query of the device B.

The comparison source data generation unit 123 generates comparison source data (teaching data or a feature vector in machine learning) using the aggregation result of the DNS query (DNS query for comparison source data) acquired from each of the devices whose model, OS, and application are known in advance.

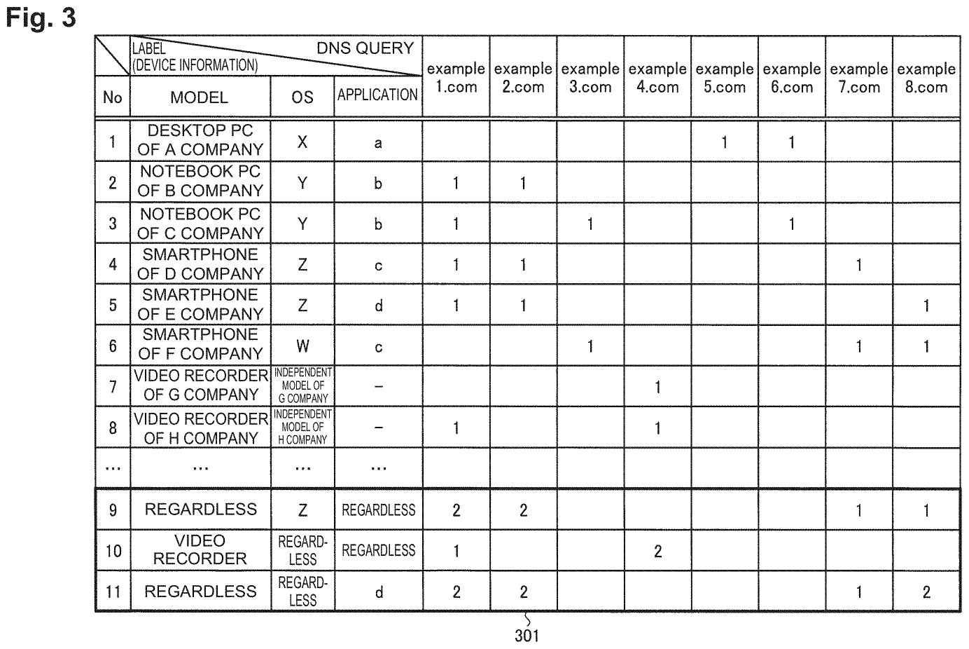

For example, the comparison source data generation unit 123 generates the comparison source data including an entry group obtained by assigning, as a label, information (device information) on the model, OS, and application of the device, which is a transmission source of the DNS query, to the aggregation result of the DNS query for the comparison source data aggregated by the aggregation unit 122 (see FIG. 3). Then, the comparison source data generation unit 123 stores the generated comparison source data in the storage unit 13. An example of the comparison source data will be described below with reference to FIG. 3.

For example, in the comparison source data shown in FIG. 3, an entry of No. 1 indicates that aggregation results of the DNS query transmitted from a device of a model “desktop PC of A company”, an OS “X”, and an application “a” are “example5.com” and “example6.com”. Further, an entry of No. 2 indicates that aggregation results of the DNS query transmitted from a device of a model “notebook PC of B company”, an OS “Y”, and an application “b” are “example1.com” and “example3.com”.

Entries Nos. 9 to 11 indicated by reference numeral 301 in FIG. 3 may or may not be included in the comparison source data, and the case of being included in the comparison source data will be described below.

The estimation unit 124 estimates the model, OS, and application of the device to be estimated using the DNS query transmitted from the device to be estimated and the comparison source data. Specifically, the estimation unit 124 acquires, from the aggregation unit 122, the aggregation result of the contents of the DNS query transmitted from the device to be estimated. Then, the estimation unit 124 extracts an entry similar to the aggregation result from the comparison source data, and estimates the model, OS, and application indicated in the extracted entry as the model, OS, and application of the device to be estimated.

Here, for example, machine learning may be used for estimating the model, OS, and application of the device to be estimated. As an example, the estimation unit 124 performs machine learning using, as a feature amount (feature vector), the aggregation result of the contents of the DNS query transmitted from each of the devices, the aggregation result being stored as the comparison source data (teaching data). Then, the estimation unit 124 estimates the model, OS, and application of the device to be estimated with Naive Bayes using the result of the machine learning from the aggregation result of the DNS query of the device to be estimated. Then, the estimation unit 124 outputs the estimation result of the model, OS, and application of the device.

The storage unit 13 stores various data that the control unit 12 refers to when estimating the model, OS, and application of the device that is the transmission source of the DNS query. For example, the storage unit 13 stores the comparison source data (see FIG. 3) described above.

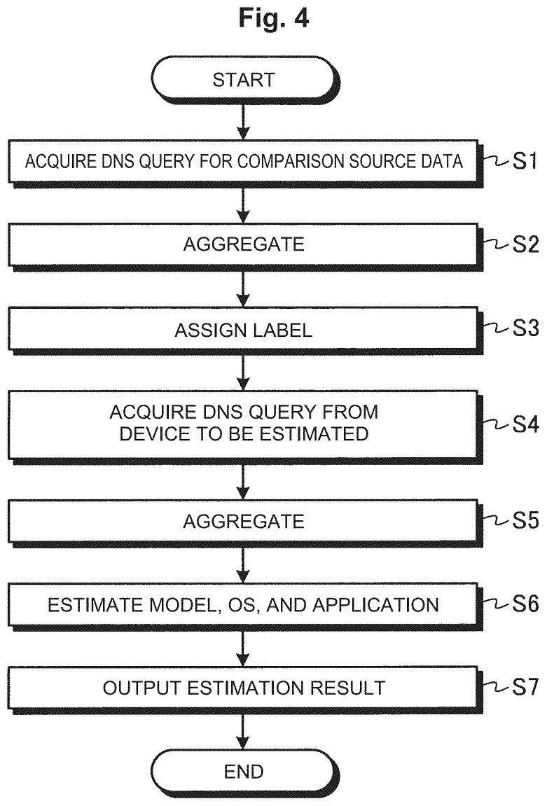

An example of a processing procedure of the device estimation apparatus 10 will be described below with reference to FIG. 4. First, the comparison source data generation unit 123 of the device estimation apparatus 10 causes the DNS query acquisition unit 121 to acquire the DNS query for the comparison source data (S1). For example, the comparison source data generation unit 123 causes the DNS query acquisition unit 121 to acquire the DNS query from each of the devices whose model, OS, and application are known in advance.

Subsequent to S1, the comparison source data generation unit 123 causes the aggregation unit 122 to aggregate the contents of the DNS query for the comparison source data acquired in S1 for each device that is the transmission source of the DNS query (S2). Subsequently, the comparison source data generation unit 123 assigns, as a label, information on the model, OS, and application of the transmission source device of the DNS query to the aggregation result of S2 (S3). Then, the comparison source data generation unit 123 stores the information (entry) assigned as the label to the aggregation result of S2 in the storage unit 13, as the comparison source data.

Subsequent to S3, when the DNS query acquisition unit 121 acquires the DNS query from the device to be estimated (S4), the estimation unit 124 causes the aggregation unit 122 to aggregate the contents of the DNS query acquired in S4 for each device that is the transmission source of the DNS query (S5).

Subsequent to S5, the estimation unit 124 estimates the model, OS, and application of the device with reference to the comparison source data stored in the storage unit 13 with respect to the aggregation result of the contents of the DNS query transmitted from the device to be estimated in S5 (S6). Then, the estimation unit 124 outputs the estimation result of the model, OS, and application of the device to be estimated (S7). For example, the estimation unit 124 extracts an entry similar to the aggregation result of the DNS query in S5 from the comparison source data, and outputs labels (model, OS, and application) indicated in the extracted entry.

Thereby, the device estimation apparatus 10 can estimate the model, OS, and application of the device in the network even in a network environment other than a network where IPv4 and IPv6 are used in combination. In addition, since the device estimation apparatus 10 causes the comparison source data generation unit 123 to generate the comparison source data, it is possible to estimate the model, OS, and application of the device in the network without manually setting the contents of the DNS query unique to each of the devices (the feature amount of the contents of the DNS query) or a communication pattern.

The device estimation apparatus 10 may estimate the model, OS, and application of the device to be estimated using at least one of a time of a retry of transmission of the DNS query from the device, an interval, a cycle, and a frequency of the retry.

That is, upon receiving an error message of the DNS query after transmitting the DNS query, each of the devices transmits the DNS query again (performs a retry). At this time, a time until each of the devices performs a DNS query transmission retry from when receiving the error message, an interval, a cycle, and a frequency of the retry may differ depending on the model, OS, and application of the device. Accordingly, the device estimation apparatus 10 may estimate the model, OS, and application of the device using, as a feature amount, at least one of the time of the retry of the DNS query transmission, the interval, the cycle, and the frequency of the retry.

In this case, for example, the device estimation apparatus 10 stores, as the comparison source data, at least one of the time until each of the devices performs the retry of the DNS query from when receiving the error of the DNS query, the interval, the cycle, and the frequency of the retry, as the feature amount.

Specifically, the device estimation apparatus 10 further includes the retry control unit 125 (see FIG. 1). The retry control unit 125 instructs the DNS server 20 to return the error of the DNS query to the device that is the transmission source of the DNS query. Thus, the retry control unit 125 causes the transmission source device of the DNS query to generate a retry of the DNS query.

First, when the comparison source data generation unit 123 generates the comparison source data, the retry control unit 125 causes each of the devices to generate a retry of the DNS query. Then, the comparison source data generation unit 123 measures, for each of the devices, at least one of a time until the retry of the DNS query is generated from when the error of the DNS query is transmitted to the device, the interval, the cycle, and the frequency of the retry. Subsequently, the comparison source data generation unit 123 generates the comparison source data including, as a feature amount, at least one of measurement results of the time until the retry of the DNS query is generated for each device, the interval, the cycle, and the frequency of the retry.

Subsequently, the estimation unit 124 causes the retry control unit 125 to generate a retry of the DNS query from the device to be estimated. Then, the estimation unit 124 measures at least one of the time until the device to be estimated generates the retry of the DNS query, the interval, the cycle, and the frequency of the retry. In addition, the estimation unit 124 causes the aggregation unit 122 to aggregate the contents of the DNS query of the device to be estimated. Then, the estimation unit 124 compares the aggregation result of the contents of the DNS query of the device to be estimated and the measurement result of the retry with the above-described comparison source data that is the feature amount, and estimates the model, OS, and application of the device. Thereby, the device estimation apparatus 10 can improve estimation accuracy of the model, OS, and application of the device to be estimated. In addition, the device estimation apparatus 10 can improve an estimation speed of the model, OS, and application of the device to be estimated. This is because the model, OS, and application of the device to be estimated can be estimated without waiting for normal re-query of DNS (re-query due to TTL (Time To Live) expiration) by causing the device to generate the retry of the DNS query due to an error of the DNS query.

Further, the comparison source data may further include data indicating a simple sum or difference, a logical sum, or a logical product of entries having the same any one of the model, the OS, and the application, as a feature amount of the device of the model, the device of the OS, or the device of the application.

For example, as indicated by reference numeral 301 in FIG. 3, the comparison source data generation unit 123 may generate, among the entries indicating the aggregation result of the DNS query transmitted from the respective device, a simple sum of entries having the same OS (entry of No. 9), a simple sum of entries having the same model (entry of No. 10), and a simple sum of entries having the same application (entry of No. 11), and may add the entries to the comparison source data. In FIG. 3, the entry of No. 9 is a feature amount of a DNS query of a device having an OS “Z”, the entry of No. 10 is a feature amount of a DNS query of a device having a model “video recorder”, and the entry of No. 11 is a feature amount of a DNS query of a device having an application “d”.

Since the comparison source data further includes the feature amount for each model, OS, and application as described above, for example even in a case of a DNS query transmitted from a device of a model or an OS not registered in the comparison source data, the estimation unit 124 may estimate the application the device, or even in a case of a DNS query transmitted from a device of an OS or an application not registered in the comparison source data, the estimation unit 124 may estimate the model of the device. Further, even in a case of a DNS query transmitted from a device of a model or an application not registered in the comparison source data, the estimation unit 124 can estimate the OS of the device.

[Program]

In addition, the device estimation apparatus 10 described in the above-described embodiment can be implemented by installing a program for realizing the function of the device estimation apparatus 10 into a desired information processing apparatus (computer). For example, by causing the information processing apparatus to execute the above-described program provided as package software or online software, the information processing apparatus can be functioned as the device estimation apparatus 10. The information processing apparatus described herein includes a desktop personal computer or a notebook personal computer. In addition, the information processing apparatus includes a mobile communication terminal such as a smartphone, a mobile phone, or a PHS (Personal Handyphone System) and PDA (Personal Digital Assistants). Further, the function of the device estimation apparatus 10 may be implemented in a cloud server.

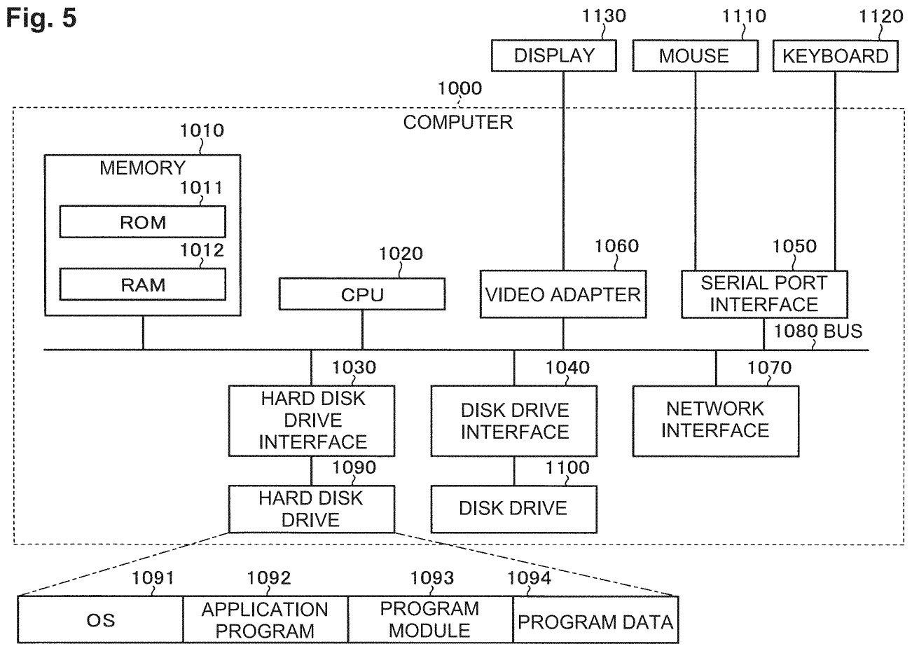

An example of a computer, which executes the above-described program (device estimation program) will be described with reference to FIG. 5. As shown in FIG. 5, a computer 1000 includes, for example, a memory 1010, a CPU 1020, a hard disk drive interface 1030, a disk drive interface 1040, a serial port interface 1050, a video adapter 1060, and a network interface 1070. These respective components are connected to each other by a bus 1080.

The memory 1010 includes a ROM (Read Only Memory) 1011 and a RAM (Random Access Memory) 1012. The ROM 1011 stores, for example, a boot program such as a BIOS (Basic Input Output System). The hard disk drive interface 1030 is connected to a hard disk drive 1090. The disk drive interface 1040 is connected to a disk drive 1100. In the disk drive 1100, a removable storage medium such as a magnetic disk or an optical disk is inserted. A mouse 1110 and a keyboard 1120 are connected to the serial port interface 1050, for example. For example, a display 1130 is connected to the video adapter 1060.

Here, as shown in FIG. 5, the hard disk drive 1090 stores, for example, an OS 1091, an application program 1092, a program module 1093, and program data 1094. Various types of data or information described in the above embodiment are stored in, for example, the hard disk drive 1090 or the memory 1010.

Then, the CPU 1020 reads the program module 1093 and the program data 1094 stored in the hard disk drive 1090 into the RAM 1012 as necessary, and executes the procedures described above.

The program module 1093 and the program data 1094 related to the device estimation program described above are not limited to being stored in the hard disk drive 1090, but may be stored in, for example, a removable storage medium and may be read by the CPU (Central Processing Unit) 1020 via the disk drive 1100. Alternatively, the program module 1093 and the program data 1094 related to the program described above may be stored in another computer connected via a network such as an LAN (Local Area Network) or a WAN (Wide Area Network), and may be read by the CPU 1020 via the network interface 1070.

### REFERENCE SIGNS LIST

10 Device estimation apparatus

20 DNS server

121 DNS query acquisition unit

122 Aggregation unit

123 Comparison source data generation unit

124 Estimation unit

125 Retry control unit

1. A device estimation apparatus comprising:
a comparison source data generation unit configured to generate comparison source data that is a set of entries in which models of devices connected to a network, software used by the devices, and an aggregation result of contents of DNS queries transmitted from the devices are associated with each other;
a DNS query acquisition unit configured to acquire a DNS query from a device to be estimated;
an aggregation unit configured to aggregate contents of the acquired DNS query for each of the devices that are transmission sources of the DNS query; and
an estimation unit configured to extract, from the comparison source data, an entry similar to an aggregation result of contents of the DNS query transmitted from the device to be estimated and to estimate, as a model and software of the device to be estimated, a model and software indicated in the extracted entry.

2. The device estimation apparatus according to claim 1, wherein the estimation unit estimates the model and the software of the device to be estimated, using a result of machine learning using the aggregation result of the DNS query in each of the entries of the comparison source data as a feature amount.

3. The device estimation apparatus according to claim 1, wherein
the device estimation apparatus further includes a retry control unit configured to generate a retry of transmission of the DNS query by returning an error to the device that is the transmission source of the DNS query, when generating the comparison source data, the comparison source data generation unit creates an entry further including at least one of a time until the retry of the transmission of the DNS query is performed from when an error is received by the device, an interval, a cycle, and a frequency of the retry, and
the estimation unit further estimates the model and the software of the device to be estimated, using a measurement result of at least one of a time until the retry of the transmission of the DNS query generated by the retry control unit is performed from the device to be estimated, an interval, a cycle, and a frequency of the retry.

4. The device estimation apparatus according to claim 1, wherein
the comparison source data further includes, among the entries, an entry indicating a simple sum, a simple difference, a logical sum, or a logical product of entries having a same model, as a feature amount of a device of the model, and
when estimating the model of the device to be estimated, the estimation unit further estimates the model of the device, using an entry indicating a simple sum, a simple difference, a logical sum, or a logical product of the entries having a same model in the comparison source data.

5. The device estimation apparatus according to claim 1, wherein
the comparison source data further includes, among the entries, an entry indicating a simple sum, a simple difference, a logical sum, or a logical product of aggregation results of contents of the DNS query in entries having same software, as a feature amount of a device using the software, and
when estimating the software of the device to be estimated, the estimation unit further estimates the software of the device, using an entry indicating a simple sum, a simple difference, a logical sum, or a logical product of aggregation results of contents of the DNS query in entries having same software in the comparison source data.

6. A device estimation method to be executed by a device estimation apparatus, the method comprising steps of:
generating comparison source data that is a set of entries in which models of devices connected to a network, software used by the devices, and an aggregation result of contents of DNS queries transmitted from the devices are associated with each other;
acquiring a DNS query from a device to be estimated;
aggregating contents of the acquired DNS query for each of the devices that are transmission sources of the DNS query; and
extracting, from the comparison source data, an entry similar to an aggregation result of contents of the DNS query transmitted from the device to be estimated and estimating, as a model and software of the device to be estimated, a model and software indicated in the extracted entry.

7. A device estimation program causing a computer to execute steps of:
generating comparison source data that is a set of entries in which models of devices connected to a network, software used by the devices, and an aggregation result of contents of DNS queries transmitted from the devices are associated with each other;
acquiring a DNS query from a device to be estimated;
aggregating contents of the acquired DNS query for each of the devices that are transmission sources of the DNS query; and
extracting, from the comparison source data, an entry similar to an aggregation result of contents of the DNS query transmitted from the device to be estimated and estimating, as a model and software of the device to be estimated, a model and software indicated in the extracted entry.
